(19) United States
(12) Patent Application Publication
(10) Pub. No.: US 2008/0309446 A1
(43) Pub. Date: Dec. 18, 2008

(54) Arrangement Comprising an Inductive Component

(76) Inventors: Wulf Guenther, Maintal (DE); Harald Hundt, Dieburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/916,598

(22) PCT Filed: Jun. 6, 2006
(86) PCT No.: PCT/EP06/05383

§ 371 Date: Jul. 11, 2008

(30) Foreign Application Priority Data
Jun. 8, 2005 (DE) 10 2005 026 410.7

(51) Int. Cl. H01F 27/30

(52) U.S. Cl. 336/185

(57) ABSTRACT

An arrangement has an inductive component with at least one insulating support (1), a magnet core (10, 16), and a winding. The support is provided with several layers (2, 3) of strip conductors which are separated from each other by at least one insulating layer (4). The magnet core is inserted into a cavity (9) of the support, between two layers of strip conductors. Pieces of conductors (5) from both layers are combined especially with through connections to form conductor windings which surround the magnet core.

### CROSS-REFERENCE TO RELATED APPLICATIONS

This application is a U.S. national stage application of International Application No. PCT/EP2006/005383 filed Jun. 6, 2006, which designates the United States of America, and claims priority to German application number 10 2005 026 410.7 filed Jun. 8, 2005, the contents of which are hereby incorporated by reference in their entirety.

### TECHNICAL FIELD

The invention refers to the field of inductive components, in particular antennas and sensors with a magnetic core and a coil for the frequency range from 15 kHz to 150 kHz.

### BACKGROUND

Rod-shaped antennas with a soft magnetic core and a conductive coil are known for the application range from 15 kHz to 150 kHz. They are used, for example, in the theft protection of motor vehicles, in identification and access control systems, as well as for the data exchange and for the simple data inquiry within a range of up to approx. 5 m and for inductive energy transfer, for example in battery recharging systems. The length of such inductive constructive elements ranges from a few cm to 1 m. appropriate magnetic cores for such antennas comprise, for example, ferrite material. This material is disadvantageous, however, due to its heavy weight and high degree of brittleness. Such a respective antenna has no strong resistance against impact or vibrations or deformations. In particular for the use in motor vehicle systems great stability against accelerations is required, which is not easily fulfilled by ferrite antennas.

The assembly of antennas having a soft-magnetic core is also difficult in electric circuits when strong accelerations occur, because these accelerations create strong forces due to the weight of the magnetic cores, which must be compensated by the soldering points. It is therefore also known to mold respective antenna elements together with circuit elements in order to increase their mechanic stability (cf. for example US 2002/033777).

In order to achieve higher stability of the magnetic cores the composite magnetic cores can be composed from amorphous and nano-crystalline tapes or thin layers with a thickness ranging from 0.5 to 30 μm (cf. DE 4109840 A1, DE 19513607 C2, EP 0762545). Such packages form highly efficient magnetic cores with a respectively low weight as well as high flexibility and can be combined to a manageable body with a coil by gluing or molding. However, this requires a relatively high production expense, because first the core must be produced, subsequently it must be stabilized and provided with a coil. Then the coil can also be molded together with the core to form a combined body. This molded body can finally be provided with connectors and inserted into an electronic circuit.

In order to reduce such a production expense it is known, for example from EP 0554486, to wind a magnetic core with a film imprinted with the conductors and here to arrange and connect the conductors such that these conductors form coils helically surrounding the magnetic core. This way, at least one coil is easily produced without the coil wire requiring to be wound multiple times around the magnetic core.

However, a multitude of technical production problems are connected thereto, because after winding the film imprinted with the conductor around the magnetic core matching conductor connectors are produced by gluing or soldering and must be permanently secured. Additionally, in these processes the magnetic material can be damaged.

From DE 19723068 C1 it is known to provide a recess in a carrier substrate carrying the conductors on one of its sides, which can accept a magnetic core. Partial sections of conductors on the carrier substrate form sections of coils for an inductor surrounding the magnetic core. Other parts of the coils are formed by bonded conductors, which are pulled over the magnetic core and contacted after the introduction of the magnetic core into the recess. This way, a continuous coil develops with bonded wires, on the one hand, and conductors, on the other hand.

This production of the inductive component requires very high production expenses, because all bonded wires must be connected individually and by nature the contacts of the bonded wires are not very stable or mechanically stress-resistant. The range of applications of this production method is therefore very limited.

A further development of the described concepts to embed the magnetic core in a circuit board is described in DE 101 22 393 A1 and DE 101 39 707 A1. Here, soft magnetic elements are directly laminated into a multi-layered circuit board. The coil can be embodied as one or more planar coils in layers above and below the area-shaped core. In circular cores a cylindrical coiling is formed by embodying the coil segments above and below the core, which are connected to a coil via throughplatings.

This construction has some disadvantages, though: The magnetic materials are incompatible with standard circuit board processes with regard to adhesion and/or adhesive strength; the lamination temperatures from 150-200° C. as well as the pressure damage the magnetic material by magnetic modification processes, distortion, or chemical changes of composite materials. When the magnetic layer covers less than the entire surface of the circuit board, the magnetic parts must be expensively placed and fixed on carriers or in pre-punched layers. Due to the fact that conventional circuit board processes also occur, among other things, with etching fluids, the magnetic material located on the inside can also be corroded by leaks or in general.

### SUMMARY

An inductive component and a method for its production can be provided with the goal to combine a simple and cost-effective production with a mechanically resistant construction. Particularly interesting are antennas or sensors comprising a flat rod-shaped core with a cylindrical coil. Furthermore, a particularly flat yet resistant and cost-effective construction can be provided that can be produced safely. The use of cheap mass manufacturing technology of circuit boards regardless of any magnetic material, and the later combination of optimally thin magnetic cores with the coil designed as a circuit board are thereby considered.

According to an embodiment, an arrangement may have an inductive component with at least one isolating carrier, a magnetic core, and a coil, with the carrier being provided with several layers of conductors, separated by at least one insulating layer, with the magnetic core being arranged between two layers of conductors in a recess of the carrier and conductor sections from the two layers being connected by throughplatings to form conductor coils surrounding the magnetic core.

### BRIEF DESCRIPTION OF THE DRAWINGS

In the following, the invention is explained in greater detail using the exemplary embodiments shown in the figures of the drawing, in which similar or equivalent parts are provided with the same reference characters. They show

FIG. 1 an arrangement according to an embodiment with conductors positioned at the outside,

FIG. 2 an arrangement according to an embodiment with conductors located at the interior walls of the recesses,

FIG. 3 an arrangement according to an embodiment with additional electronic elements,

FIG. 4 an arrangement similar to the one shown in FIG. 3 with additional fastening elements,

FIG. 5 an arrangement according to an embodiment having several carriers.

### DETAILED DESCRIPTION

The magnetic core according to an embodiment is essentially arranged inside the carrier and thus protected and insulated from the outside. The coil can be embodied very simply by a design of the respective conductors of different layers in the carrier. If necessary, here the coils can be arranged closer or farther apart from each other. The conductor sections at both sides of the magnetic core are here connected to each other by respective throughplatings perpendicular to the flat sides of the carrier or conductors to the exterior of the carrier. The throughplatings can for example be formed by metal pins penetrating the carrier and soldered to the conductors. The developing arrangement can be used in a multitude of devices in a place-saving manner and is characterized by strong mechanic resistance.

Another embodiment provides that the conductor sections extend parallel in reference to each other and perpendicular to the longitudinal axis of the magnetic core with a slight incline in reference to the longitudinal axis in order to achieve an inclined coil.

This way, a particularly tight coil can be easily embodied. The conductors can extend precisely perpendicular in reference to an axis of the magnetic core on one side of the carrier. The throughplatings can extend through the carrier perpendicular in reference to the surfaces carrying the conductors.

Different from prior art and circumventing the problems connected thereto and described above, it is provided that the recess has an opening towards the narrow side of the carrier, through which the magnetic core is inserted after the production of the carrier and is fixed in the recess, for example by clamping, gluing, or molding. This way, the production processes for the carrier and the core are implemented entirely separate from each other and in spite thereof result in a safe integration of both elements. This way is particularly suitable for rod-shaped cores and circumvents all influences of the production process of the carrier including the conductors on the magnetic material of the core.

The magnetic core can then either be embedded completely in the recess or protrude from the opening. When the magnetic core protrudes from the opening generally the second end can also be fixed in a recess of a second carrier, and here also be surrounded by a coil. This way the magnetic core can form a connection member between two carriers each having separate conductors.

A particularly beneficial production method for the arrangement according to an embodiment provides that in the production of the carrier having conductors the recess is provided in at least one of the interior layers to accept the magnetic core. This can occur for example such that during the layering of the carrier an individual insulating layer is provided with a recess, e.g., by way of punching, into which a magnetic core matches. However, recesses may also be provided in several consecutive layers of the carrier.

When laminating the different layers it must be observed that no adhesive enters the recess, which later prevents the insertion of the core. For this purpose, for example a metallic or plastic part, e.g., Teflon, can fill the hollow space as a placeholder, which is removed (pulled out) after the lamination process. Additionally, in the finished carrier a recess can be inserted by mechanical post-processing, such as e.g., cutting, or an existing one can be cleaned.

According to another embodiment, the carrier already carries electric components to contact the inductive element even prior to the introduction of the core. In this case the integration level of the overall arrangement is particularly high. The electric components can for example serve to contact the inductive element in the form of an antenna (transmitting or receiving antenna) or a sensor, e.g., a magnetic positioning sensor.

A particularly high mechanical stability is achieved such that after the introduction of the magnetic core into the carrier it is adhered, molded, or at least sealed at the opening of the recess. The magnetic core can be clamped into the recess of the carrier and here an additional elastic body can be added for clamping as well.

Depending on the special electric, magnetic, and mechanic requirements the individual insulating layers of the carrier may comprise plastic, ceramics, or a semi-conductor element. The conductors positioned between, above, and below these insulating layers may comprise, for example, copper or silver.

It must be mentioned with regard to the magnetic cores used that they may comprise for example an amorphous or nano-crystalline material on a Fe or Co basis, which is produced by rapid setting technology. Thin layers or rods with thicknesses ranging from approximately 10 to 30 μm are combined by way of bundling and/or layering to packages, which can be bent elastically. The use of ferrite material is also possible, however due to their brittleness they have no comparable mechanic stability.

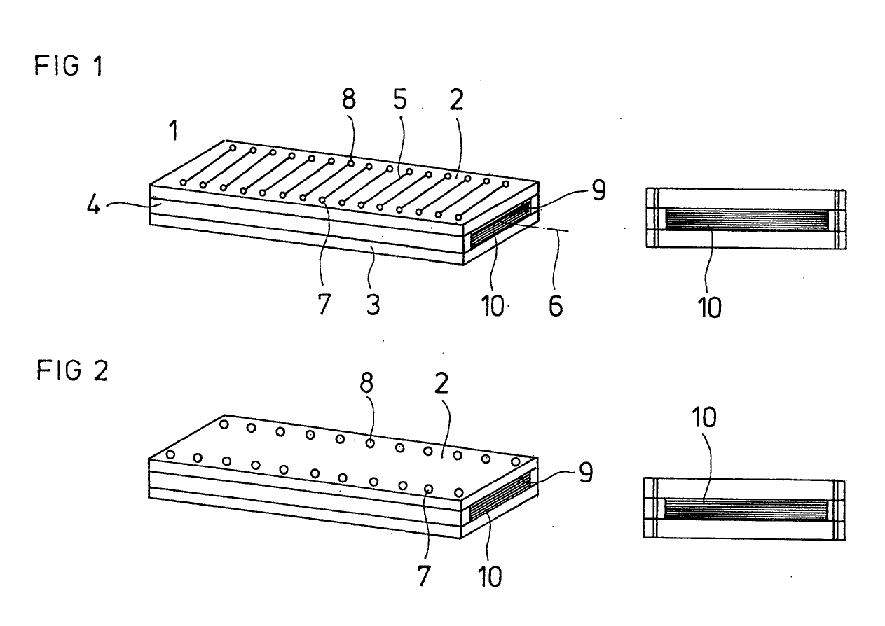

FIG. 1 shows an arrangement according to an embodiment with a carrier 1, carrying a first layer 2 of conductors on its upper side, as well as a second layer 3 of conductors on its bottom, and a third layer 4 therebetween, comprising an insulating material. The first layer 2 itself may be divided into a conducting film and an insulating layer carrying it. The second layer 3 can be designed in the same manner. In the first layer 2, by way of industrial methods known, such as the printing or etching of conductors, a multitude of conductors 5 are inserted, which extend parallel in reference to each other and which are almost perpendicular in reference to the carrier axis 6 of the carrier 1, which are however at a slight incline in reference to the longitudinal axis. Throughplatings 7, 8 are allocated to each of these conductor sections 5 at each of their ends, which comprise for example a metal pin, penetrating the first, second, and third layer of the carrier and soldered to the conductor at its end. The throughplatings therefore penetrate the carrier 1 to the second layer 3, which is designed in the same manner as the first layer 2, and the throughplatings also hit the ends of conductor sections. The conductor sections and the throughplatings are formed and arranged such that combined they surround a hollow space 9 in a carrier 1, embodied as a recess, in a screw or coil shaped manner. One beginning of the coil developing in this manner is arranged at the right end of the carrier 1, one end at the left end of the carrier 1. Here, the respective connectors are formed for the coil. The conductors comprise copper or silver or another suitable conductive material, as well as the pins.

In the hollow space 9, a magnetic core 10 comprising a soft magnetic material is inserted, in particular an amorphous iron or cobalt-based material produced by rapid setting technology.

Advantageously the magnetic core can be made such that it is low in magnetic striction. For example, it comprises a stack of very thin (10 to 30 μm) and approximately 1 to 20 mm wide, preferably 5 to 15 mm wide strips. By this composition of the magnetic core as a bundle or stack it becomes very flexible and mechanically very resistant. After the bundling the magnetic core itself can also be molded with resin into a stable body.

The magnetic body can end flush with the carrier 1 at the outside, however, it may also be inserted into the recess 9 to such an extent that its face is recessed behind the edge contour of the carrier 1, so that the carrier 1 overall can be molded to the magnetic core by the remaining hollow space being filled in.

A coil develops with a magnetic core, which has small structural dimensions with a high inductivity and can be produced with little expense.

FIG. 2 shows a similar carrier as FIG. 1, however, here the first layer 2 and the second layer 3 are quasi inversed, so that their conductors point inwardly towards the hollow space 9. At each of its exterior sides the carrier is provided with insulating layers protecting the conductors towards the outside. For the rest, the throughplatings 7, 8 are embodied equivalent to FIG. 1 and thus also a hollow space 9 develops surrounding a conductor coil. When a respective magnetic core is inserted into the recess 9, the inductive component according to an embodiment develops. Here, it may be useful additionally to provide a cover layer over the conductors inside the recess 9 in order to avoid damages to the conductor sections 5 when inserting the magnetic core or to avoid general damages. The cover layer can for example be embodied by a film or by way of enameling.

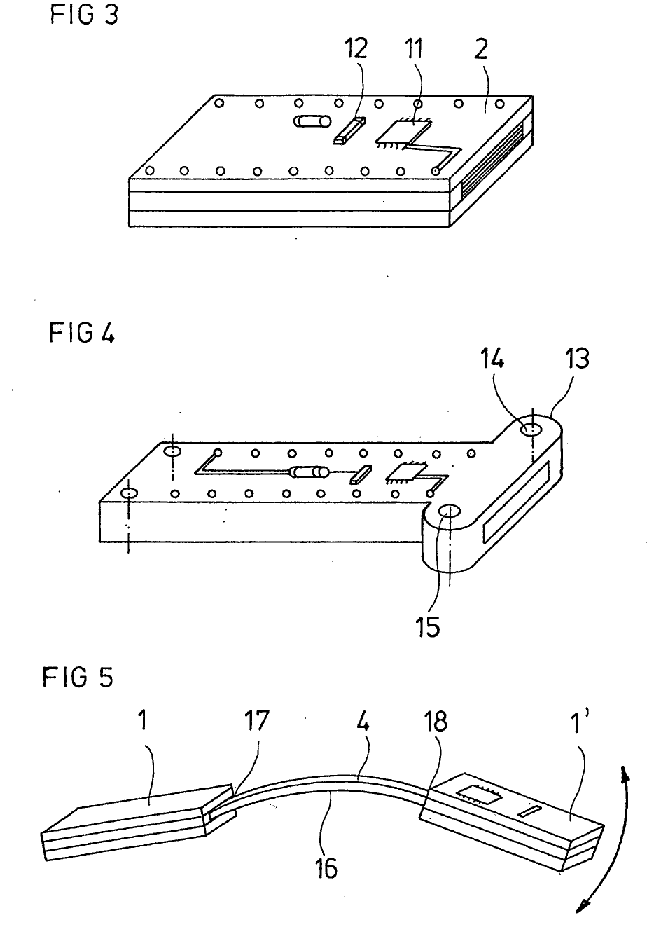

FIG. 3 shows a carrier as discernible from FIG. 2, with the first layer 2 being additionally used to provide and contact electronic components 11, 12 here, due to the existing conductors and the possibility to provide additional conductors. They preferably comprise components necessary for the control circuit of the inductive component, in particular necessary for an antenna. This way, a transmitting or receiving module develops, which is highly integrated and place-saving and can be produced in a simple manner.

The carrier according to an embodiment can here be produced completely by industrial methods, such as an automatic in-line assembly of circuit boards. The components 11, 12 can be mounted in SDM-technology, for example. By the possibility of a subsequent insertion of the magnetic core according to an embodiment influences of the soldering process (e.g., temperatures >200° C.) on the magnetic core are excluded.

FIG. 4 shows, in addition to the design shown in FIG. 3, an enlargement 13 of the carrier 1, in which bores 14, 15 are provided to fasten the carrier to a housing or another circuit board.

FIG. 5 shows two carriers 1, 1′, each of which being provided with a recess for a magnetic core as well as a long magnetic core 16, which, as shown, is very flexible and protrudes with its ends 17, 18 each into a recess of a carrier 1, 1′. This way, in applications requiring relatively long magnetic cores, the respective electronics necessary in the context of using of the magnetic core, can be integrated in the structure in a space-saving manner and the entire arrangement can easily be adjusted to the different implementation conditions, for example the installation in motor vehicles, where the overall arrangement can easily be adjusted to the available hollow space by way of bending. The two coils formed at the ends of the carrier in this manner and distanced from each other can be used separately or be connected to each other via a conductor.

What is claimed is:

1. An arrangement with an inductive component comprising at least one isolating carrier, a magnetic core, and a coil, wherein the carrier is provided with several layers comprising conductors separated from each other by at least one insulating layer, the magnetic core being arranged between two layers of conductors in a recess of the carrier, and conductor sections of both layers each being connected to conductor coils surrounding the magnetic core.

2. The arrangement according to claim 1, wherein the magnetic core is inserted into the recess in the prefabricated carrier through an opening at the narrow side of the carrier.

3. The arrangement according to claim 1, wherein the conductor sections extend parallel in reference to each other and perpendicular in reference to the longitudinal axis of the magnetic core with a slight incline in reference to the longitudinal axis, in order to achieve inclined coils.

4. The arrangement according to claim 1, wherein the carrier carries electronic components for connecting the inductive component.

5. The arrangement according to claim 1, wherein the magnetic core is inside the carrier glued, molded, clamped, sealed, or otherwise connected to the carrier in a fixed manner.

6. The arrangement according to claim 1, wherein the carrier comprises plastic.

7. The arrangement according to claim 1, wherein the carrier comprises ceramics.

8. The arrangement according to claim 1, wherein the carrier comprises a semi-conductor element.

9. The arrangement according to claim 2, wherein the magnetic core protrudes from the opening.

10. The arrangement according to claim 1, wherein the two ends of a magnetic core are arranged in openings of different carriers.

11. The arrangement according to claim 1, wherein the conductor sections of the two layers each are to be connected to conductor coils by way of throughplatings.

12. The arrangement according to claim 1, wherein the magnetic core comprises soft magnetic material.

13. The arrangement according to claim 12, wherein the soft magnetic material is an amorphous iron or cobalt based material made in a rapid setting process.

14. The arrangement according to claim 1, wherein recess for accepting the magnetic core is provided in the production of the carrier having the conductors in at least one layer.

15. The arrangement according to claim 14, wherein during the production of the carrier a body is temporarily inserted into the recess as a placeholder instead of the magnetic core.

16. The arrangement according to claim 14, wherein the carrier has a curved shape in the longitudinal or lateral direction.

17. An arrangement with an inductive component comprising
at least one isolating carrier comprising several layers having conductors separated from each other by at least one insulating layer,
a magnetic core arranged between two layers of conductors of the several layers in a recess of the carrier, and
a coil, wherein conductor sections of both layers each being connected to conductor coils surrounding the magnetic core.

18. The arrangement according to claim 17, wherein the magnetic core is inserted into the recess in the prefabricated carrier through an opening at the narrow side of the carrier.

19. The arrangement according to claim 17, wherein the conductor sections extend parallel in reference to each other and perpendicular in reference to the longitudinal axis of the magnetic core with a slight incline in reference to the longitudinal axis, in order to achieve inclined coils.

20. The arrangement according to claim 17, wherein the carrier carries electronic components for connecting the inductive component.
